(19) United States
(12) Patent Application Publication
(10) Pub. No.: US 2024/0095786 A1
(43) Pub. Date: Mar. 21, 2024

(54) PRODUCT DESIGN GENERATION SUPPORT DEVICE, PRODUCT DESIGN GENERATION SUPPORT METHOD, AND PROGRAM STORAGE MEDIUM

(71) Applicant: NEC Corporation, Minato-ku, Tokyo (JP)

(72) Inventors: Makoto Takamoto, Tokyo (JP); Daniel Onoro Rubio, Heidelberg (DE)

(73) Assignee: NEC Corporation, Minato-ku, Tokyo (JP)

(21) Appl. No.: 18/273,516

(22) PCT Filed: Mar. 31, 2021
(86) PCT No.: PCT/JP2021/013820

§ 371 Date: Jul. 20, 2023

(51) Int. Cl. G06Q 30/0282; G06N 5/022; G06T 7/20

(52) U.S. Cl. CPC G06Q 30/0282; G06N 5/022; G06T 7/20; G06T 2207/30201; G06T 2207/30241

(57) ABSTRACT

To generate and present effective information for making and determining a product design, this product design generation support device includes: an acquisition unit; a design classification unit; and an output unit. The acquisition unit acquires design information of each of a plurality of designs of the subject product that are different to each other and line-of-sight information of the subject person for those designs. The design classification unit classifies the plurality of designs into a plurality of groups according to the acquired design information and line-of-sight information. The output unit outputs the classification results.

### TECHNICAL FIELD

The present invention relates to a technique for providing information on how a product design looks.

### BACKGROUND ART

In order to decide the design of a new product or a renewed product, product purchasers' responses from questionnaires regarding the designs of products collected before or results of monitoring tests may be referred to.

PTL 1 (JP 2017-41123 A) discloses a technique for obtaining knowledge of how to promote sales of products. The system disclosed in PTL 1 outputs information indicating problems of a target object (product) (for example, information on whether to improve the package of the product or to enhance the brand power of the product) based on numerical values indicating the amount of a gaze at the product and numerical values indicating an interest in the product.

### CITATION LIST

### Patent Literature

PTL 1: JP 2017-41123 A

### SUMMARY OF INVENTION

### Technical Problem

The information on product designs obtained from the answers to questionnaires and the results of monitoring tests as described above is often simple impressions such as that it is good with a bright feeling, the combination of colors is not preferred, or the picture of a character is cute. For this reason, it may be difficult for the product developer or the designer to determine which part of the product design should be focused on to implement (generate) the design of the product from the answers from questionnaires and the results of monitoring tests.

In the case of referring to the information output from the system described in PTL 1, the product developer or the designer can grasp whether there is any point to be improved in the package of the product. However, if there is a point to be improved in the package of the product, since the above information output from the system is information indicating that there is a point to be improved, it is considered as to be difficult for the product developer or the designer to determine which part of the product design should be focused on to implement (generate) the design of the product even by referring to the information.

The present invention has been devised in order to solve the above problems. That is, a main object of the present invention is to provide a technology capable of supporting implementation (generation) of the design of a product.

### Solution to Problem

In order to achieve the above object, a product design generation support device in an aspect of the present invention includes
an acquisition unit that acquires design information of each of a plurality of different designs of a target product and gaze information of a target person to the design,
a design classification unit that classifies the plurality of designs into a plurality of groups based on the design information and the gaze information acquired by the acquisition means, and
an output unit that outputs a result of the classification.

A product design generation support method in an aspect of the present invention includes,
by a computer,
acquiring design information of each of a plurality of different designs of a target product and gaze information of a target person to the design,
classifying the plurality of designs into a plurality of groups based on the design information and the gaze information, and
outputting a result of the classification.

A program storage medium in an aspect of the present invention stores a computer program for causing a computer to execute
acquiring design information of each of a plurality of different designs of a target product and gaze information of a target person to the design,
classifying the plurality of designs into a plurality of groups based on the design information and the gaze information, and
outputting a result of the classification.

### Advantageous Effects of Invention

According to the present invention, it is possible to provide a technique that is capable of suitably supporting the implementation (generation) of design of a product.

### BRIEF DESCRIPTION OF DRAWINGS

FIG. 1 is a diagram illustrating a configuration of a product design generation support device in a first example embodiment.

FIG. 2 is a diagram for describing design elements.

FIG. 3 is a diagram illustrating an example of a central location test.

FIG. 4 is a diagram illustrating a trajectory of a gaze and a gaze staying time.

FIG. 5 is a diagram for further describing a trajectory of a gaze and a gaze staying time.

FIG. 6 is a diagram illustrating an example of a graph (knowledge graph).

FIG. 7 is a diagram illustrating a display example of cluster information.

FIG. 8 is a flowchart illustrating an example of operations of a product design generation support device in the first example embodiment.

FIG. 9 is a diagram illustrating an example of a graph (knowledge graph) used in a second example embodiment.

FIG. 10 is a diagram illustrating a display example of classification reasons.

FIG. 11 is a diagram illustrating an example of a graph (knowledge graph) used in a fourth example embodiment.

FIG. 12 is a diagram illustrating a configuration of a product design generation support device in a fifth example embodiment.

FIG. 13 is a diagram illustrating display examples of representative images.

FIG. 14 is a diagram illustrating a configuration of a product design generation support device in a sixth example embodiment.

FIG. 15 is a diagram illustrating a display example representing classification results of design candidates.

FIG. 16 is a diagram illustrating a configuration of a product design generation support device in another example embodiment.

FIG. 17 is a flowchart illustrating an example of operations of a product design generation support device in another example embodiment.

### EXAMPLE EMBODIMENT

Hereinafter, example embodiments according to the present invention will be described with reference to the drawings.

### First Example Embodiment

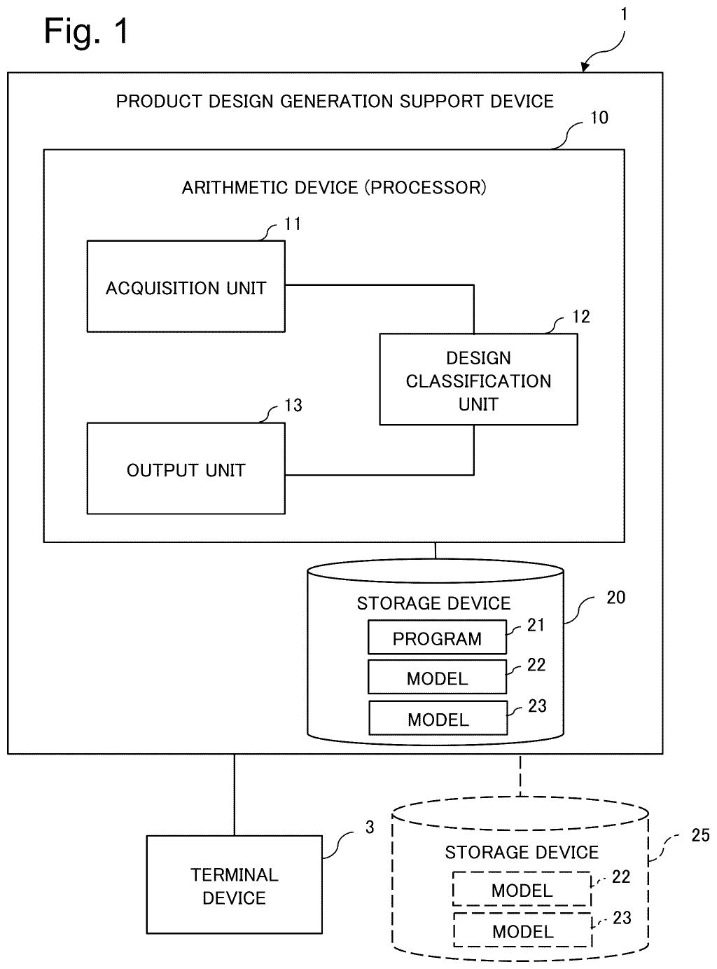

FIG. 1 is a diagram illustrating a configuration of a product design generation support device of a first example embodiment according to the present invention. The product design generation support device 1 of the first example embodiment has a function of providing information about how the design of a target product looks. In the following description, the product design generation support device will be also referred to as a support device in short.

The target product here is a product to be searched for a design. Products include not only tangible products such as foods, toys, miscellaneous goods, furniture, home appliances, and clothes, but also intangible products such as services and information. The product discussed herein is a tangible product. The design of the product includes the shape, pattern, or color(s) of the product, or a combination thereof. Some products are provided in a form in which contents such as foods, toys, and miscellaneous goods are contained in a package. In the case of a product including such a package, the design of the product targeted by the support device 1 may be the design of either the package or the content thereof, or may be the design of each of or a combination of the package and the contents. Although the support device 1 can support any of such designs, in the first example embodiment, the configuration of the support device 1 will be described using the design of a package of a product (hereinafter, also referred to as a package design) as an example.

The support device 1 is a computer (for example, a server or the like arranged in a data center), and can be connected to the terminal device 3 via a wired or wireless information communication network as illustrated in FIG. 1, for example. The terminal device 3 is a personal computer (PC), a tablet, a smartphone, a wearable terminal, or the like, and a plurality of pieces of design information of a target product and gaze information of a plurality of persons are transmitted from the terminal device 3 to the support device 1, for example.

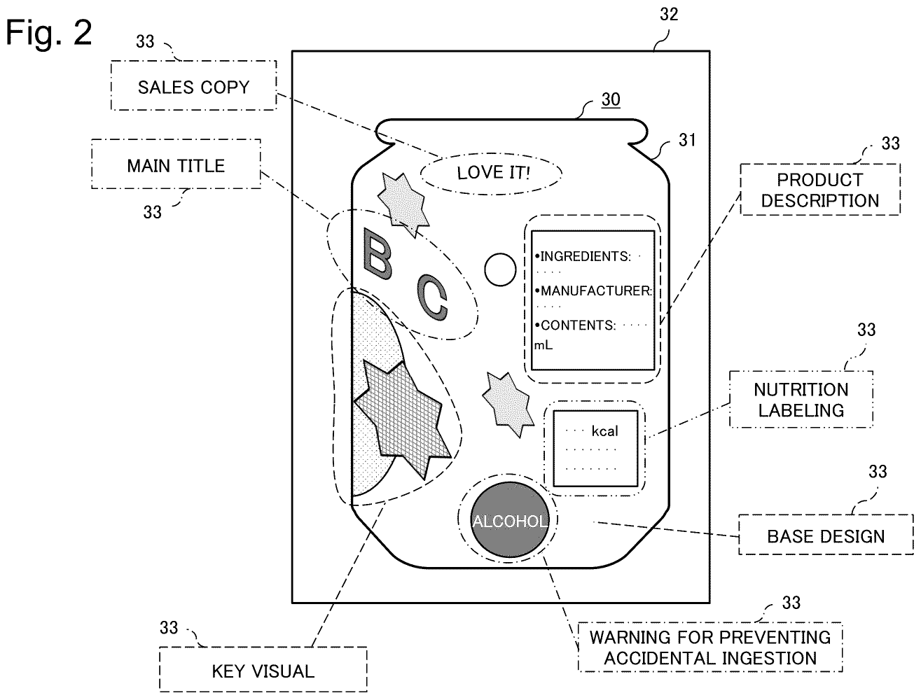

The plurality of pieces of design information is information representing a plurality of different designs of the target product. In the first example embodiment, the design information includes a design image 32 as illustrated in FIG. 2. The design image 32 is an image representing the design of the product, such as a photographed image obtained by photographing the design of the product or an illustration image in which the design of the product is drawn.

In the first example embodiment, the design information includes not only the design image 32 but also explanatory information 33 of design elements. The design elements are elements constituting a design. In a package design of a can beverage as illustrated in FIG. 2, for example, the design elements include a main title, a catch copy, a key visual, a base design, a product description (raw material names, manufacturer's name, internal capacity, alcohol content, etc.), a nutrition labeling, and a warning for preventing accidental ingestion. Although not illustrated in FIG. 2, the design elements include a mark of can material can (aluminum, steel, etc.), a caution (“Empty cans to trash box”, “The drinking age is 20”, and the like), a two-dimensional code, an indication of a taste, an indication of a beverage type, and an indication of origin of the main ingredient. Furthermore, the design elements include information on the characteristic shape of the package, information on the material of the package, and the like.

The design element explanatory information 33 includes the names of the design elements as described above (for example, main title, key visual, and the like), information indicating the positions of the design elements in the design image 32, and information related to the design. The information related to the design includes information indicating arrangement position in the package, size information (for example, the ratio of the occupied area (occupancy) to the surface area of the entire package, the font size of characters, and the like), information indicating a color system, and the like, for example.

In the first example embodiment, a plurality of pieces of design information on different designs, such as different colors of base design of the target product, different key visuals, and different main title fonts, are transmitted from the terminal device 3 to the support device 1.

The gaze information of a person is information on the gaze of a target person on the design of a target product, and includes the trajectory of a gaze, a gaze staying time, and the like, for example. The trajectory of a gaze is the movement of the gaze when the person is looking at the design of the target product. The gaze stay information includes a portion of the design of a target product on which a person has rested their eye and a time during which the person has rested their eye on the portion of the design of the target product. Such gaze information can be acquired in a site (test site) where a central location test (CLT) on the design of the target product is conducted, for example. The CLT is a test method by which subjects (testers) are gathered in a preset site (test site) to response to questionnaires (including interviews). For example, in a CLT on product design, testers are asked whether they want to purchase the product at the sight of the product design. The testers are also requested to make a remark (comment) on the design of the product.

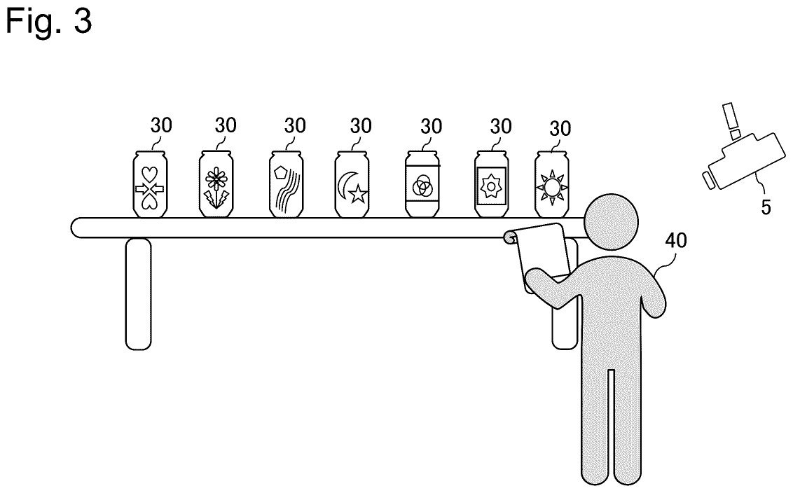

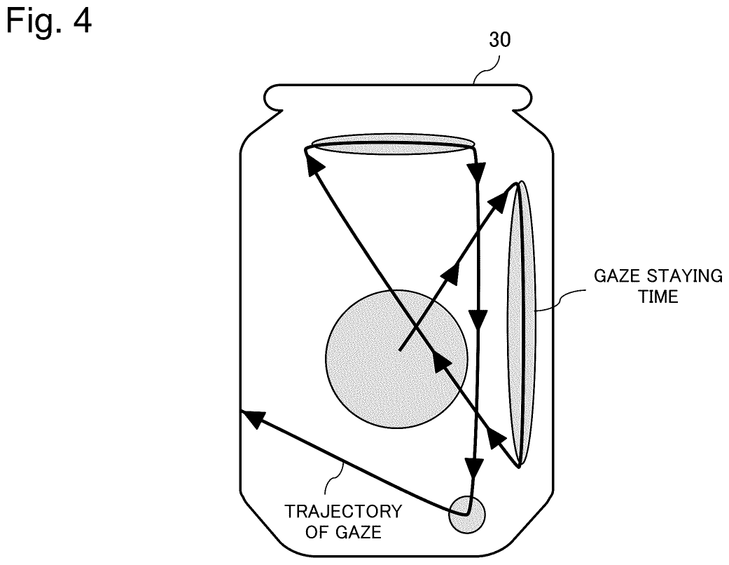

FIG. 3 is a diagram illustrating an example of a state of a test site where a CLT on a package design of a target product 30 is conducted. In the test site, a plurality of target products 30 having different package designs are arranged as illustrated in FIG. 3, for example. At least the face of a tester 40 looking at the target products 30 arranged in this manner is imaged by the imaging device 5. Analyzing the image (or moving image) captured in this manner makes it possible to acquire gaze information such as how the tester 40 moves the eye to look at the package design of each target product 30. FIG. 4 is a diagram illustrating gaze information acquired by analysis of a captured image, as a concept image. In the example of FIG. 4, lines representing the trajectory of a target person's gaze at the target product 30 and graphic images representing the gaze staying times are superimposed on the image of the package design of the target product 30. Each graphic image representing the gaze staying time is located at a portion where the person has rested their eye, and has an area corresponding to the gaze staying time. The target person here is a person who is looking at the target product 30, and as an example, is a target person (tester) of a CLT. In the example of FIG. 4, the gaze staying times are represented by graphic images, but the gaze staying times may not necessarily be represented by graphic images. For example, the gaze staying times may be represented by numerical values (number of seconds).

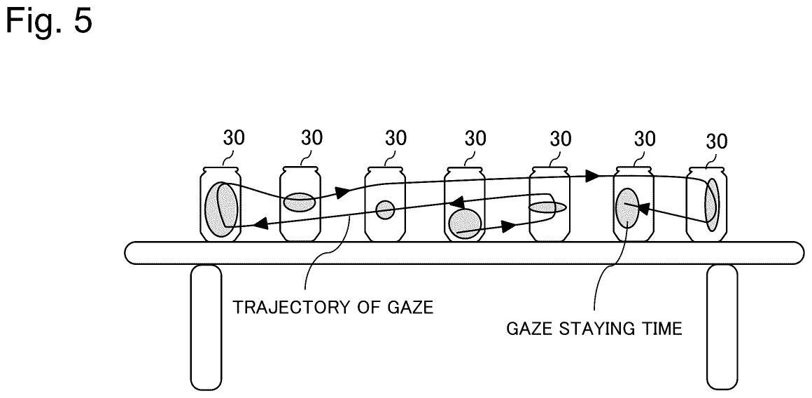

Analyzing the captured image also makes it possible to acquire gaze information such as the order in which the tester 40 has viewed the plurality of target products 30 arranged side by side and where the tester 40 has rested their eye. FIG. 5 is a diagram illustrating gaze information acquired by analyzing a captured image of a plurality of target products 30 arranged side by side, as a concept image. As in FIG. 4, in the example of FIG. 5, lines representing the trajectory of the person's gaze and graphic images representing the gaze staying times are superimposed on the image of the package design of the plurality of target products 30 arranged side by side.

The gaze information further includes visual recognition time, the number of times of visual recognition, visual recognition ratio, and the like for the target product. The visual recognition time is a time during which the tester 40 has looked at a certain target product 30. The number of times of visual recognition is the number of times the tester 40 has looked at a certain target product 30 in a situation where the plurality of target products 30 are arranged side by side. The visual recognition ratio is the ratio of the time during which the tester 40 has looked at a certain target product 30 to the time during which the tester 40 has looked at the plurality of target products 30 arranged side by side, or the ratio of the number of times the tester 40 has looked at a certain target product 30 to the total number of times the tester 40 has looked at the plurality of target products 30. At the test site of a CLT or the like, prototypes, comparative products, and others that are not actually sold as products may be arranged. Herein, such prototypes, comparative products, and the like are also referred to as products.

In the first example embodiment, the gaze information as described above of a plurality of testers 40 (persons) is transmitted from the terminal device 3 to the support device 1. The gaze information transmitted by the terminal device 3 may be information obtained by analysis of a captured image by the terminal device 3 or may be information obtained by analysis of a captured image by a computer device different from the terminal device 3 and acquired by the terminal device 3. In the first example embodiment, the design information as described above transmitted from the terminal device 3 to the support device 1 is information indicating the package design of the target product 30 viewed by the tester 40. It is necessary to associate the target product 30 in the gaze of the tester 40 with the design information of the target product 30. There are various methods for associating such information, and any method may be adopted here, and the description thereof will be omitted.

As illustrated in FIG. 1, the support device 1 according to the first example embodiment includes an arithmetic device 10 and a storage device 20. The storage device 20 has a configuration for storing various types of data and a computer program (hereinafter, also referred to as program) 21 for controlling the operation of the support device 1, and is formed of a storage medium such as a hard disk device or a semiconductor memory, for example. The number of storage device(s) included in the support device 1 is not limited to one, and a plurality of types of storage devices may be included in the support device 1. In this case, the plurality of storage devices will be collectively referred to as storage device 20.

In the first example embodiment, the storage device 20 further stores models 22 and 23 to be used by the arithmetic device 10. The model 22 is a model that turns nodes and edges of a graph (also referred to as a knowledge graph) into vectors using a graph artificial intelligence (AI) technology. The model 23 is a clustering model that classifies a plurality of pieces of data into a plurality of groups (hereinafter, also referred to as clusters) by using a non-hierarchical clustering method, for example.

The support device 1 may be connected to an external storage device 25 as indicated by dotted lines in FIG. 1, and the models 22 and 23 may be stored in the storage device 25 instead of the built-in storage device 20. In this case, the support device 1 can use the models 22 and 23 by communicating with the storage device 25 in a wired or wireless manner.

The arithmetic device 10 includes a processor such as a central processing unit (CPU) or a graphics processing unit (GPU), for example. The arithmetic device 10 can perform various functions when the processor executes the program 21 stored in the storage device 20. In the first example embodiment, the arithmetic device 10 includes an acquisition unit 11, a design classification unit 12, and an output unit 13 as functional units.

That is, the acquisition unit 11 acquires a plurality of pieces of design information of the target product 30 transmitted from the terminal device 3. As described above, the plurality of pieces of design information is design information for each of the plurality of different designs of the target product 30, and here, is design information of the plurality of target products 30 tested by a CLT or the like.

The acquisition unit 11 further acquires gaze information of a plurality of persons. The plurality of persons is the testers 40 of a CLT, for example, and in the CLT, the designs of the target product 30 corresponding to the design information acquired by the acquisition unit 11 as described above are tested. The gaze information acquired by the acquisition unit 11 is gaze information obtained by analyzing the image captured by the imaging device 5 as described above, and includes at least one of the trajectory of the gaze and the gaze staying time, for example.

In the above example, the acquisition unit 11 acquires the gaze information from the terminal device 3. Alternatively, for example, the terminal device 3 may transmit the captured image before analysis to the support device 1, a computer (server) constituting the support device 1 may analyze the captured image received from the terminal device 3 to generate the gaze information, and the acquisition unit 11 may acquire the generated gaze information. The design information and the person information acquired by the acquisition unit 11 are stored in the storage device 20.

The design classification unit 12 classifies the plurality of designs into a plurality of groups (clusters) based on the design information and the gaze information acquired by the acquisition unit 11. In the first example embodiment, the design classification unit 12 classifies the design using the models 22 and 23.

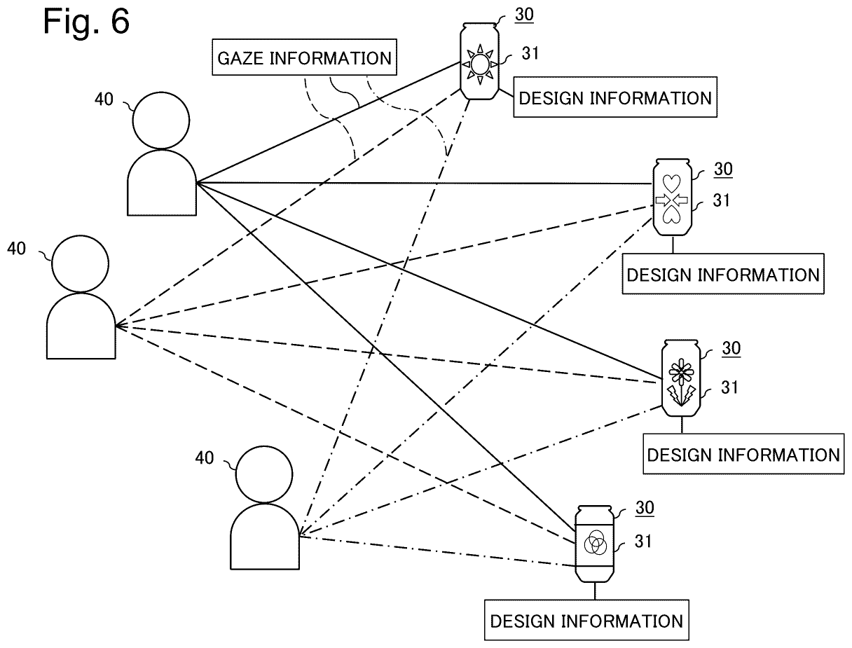

For example, the design classification unit 12 first generates a graph as illustrated in FIG. 6 using the design information and the gaze information of the persons acquired by the acquisition unit 11. The generated graph is a graph in which the designs 31 of the target products 30 and the persons (testers 40) are set as nodes and the gaze information is set as edges.

The design classification unit 12 then turns the nodes and edges in the graph into vectors using the model 22 by the graph AI technology. That is, the information related to the nodes and edges in the graph is transformed into feature vectors using the model 22.

The design classification unit 12 further classifies the plurality of designs 31 of the target products 30 into a plurality of clusters based on the feature vectors representing the nodes and the clustering model 23. That is, the model 23 is a model that classifies the plurality of designs 31 into a plurality of clusters (groups) using the feature amounts of the designs 31 based on the design information and the gaze information.

Specific examples of the clusters into which the designs 31 are classified by the design classification unit 12 include a cluster of designs in which the gaze information is reflected and attention is focused on the title, a cluster of designs in which the gaze is less stable, and a cluster of designs in which attention is focused on the key visual. Such cluster information is stored in the storage device 20.

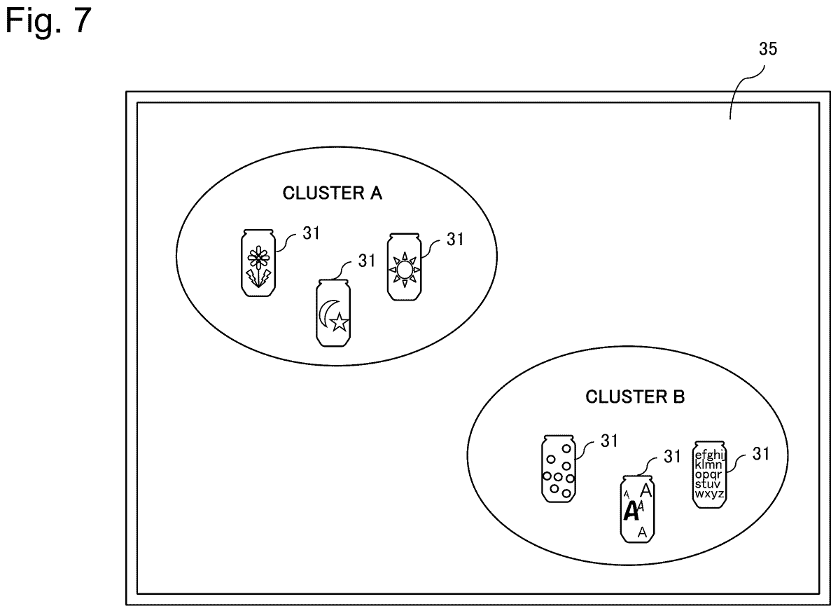

The output unit 13 outputs results of classification by the design classification unit 12. For example, the output unit 13 outputs cluster information indicating clusters as the result of classification. An example of the cluster information is information including design identification information for identifying a design image and cluster identification information for identifying a cluster into which the design 31 represented by the design image is classified. Such cluster information is transmitted to the terminal device 3, for example, and is displayed on the display device by the display control operation of the terminal device 3. FIG. 7 is a diagram illustrating a display example of the design classification results on the display device. In the example of FIG. 7, a plurality of design images associated with the same cluster identification information is displayed in a group as one cluster on a screen 35 of the display device, based on the cluster information and the design image.

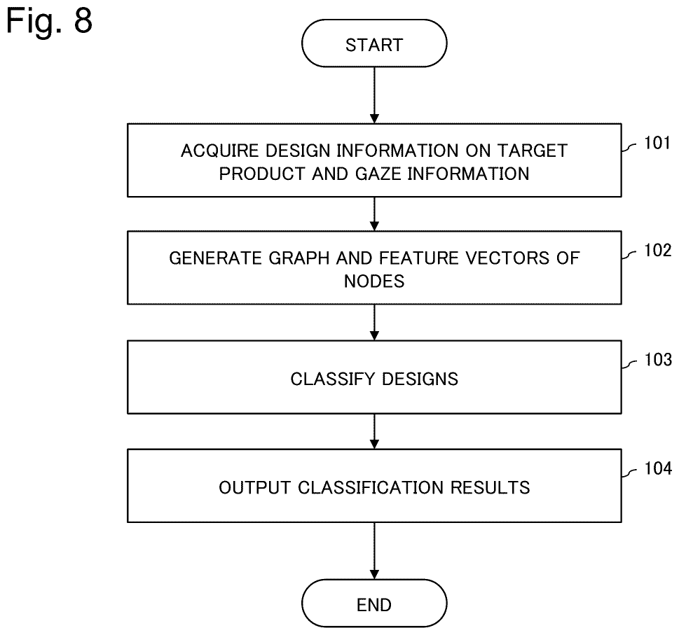

The support device 1 according to the first example embodiment is configured as described above. Hereinafter, an example of operations related to design classification (clustering) in the arithmetic device 10 will be described with reference to FIG. 8. FIG. 8 is a flowchart illustrating an example of design classification operations in the arithmetic device 10.

First, for example, the acquisition unit 11 of the arithmetic device 10 acquires the design information of the target product 30 transmitted from the terminal device 3 and the gaze information of the target persons with respect to the designs 31 of the target product 30 (step 101). Thereafter, the design classification unit 12 uses the acquired design information and gaze information of the persons to generate a graph in which the designs and the persons are set as nodes and the gaze information is set as edges. The design classification unit 12 further generates feature vectors of the nodes and edges in the graph using the model 22 (step 102).

Thereafter, the design classification unit 12 classifies the plurality of designs 31 of the target product 30 into a plurality of clusters using the feature vectors representing the nodes and the model 23 (step 103). The output unit 13 then outputs the cluster information as the classification results of the designs 31 (step 104).

As described above, the support device 1 according to the first example embodiment is configured to classify the plurality of designs 31 of the target product 30 into the plurality of clusters using the gaze information, and output the results of the classification. That is, the support device 1 can provide knowledge about how the various designs of the target product 30 are generally seen. By using the information provided by the support device 1, a product developer or a designer can easily determine which part of the design of a product should be focused on to implement (generate) the design of a product. As described above, the support device 1 generates and presents information effective for implementing and deciding the design of a product, thereby producing an advantage of favorably supporting implementation (generation) of the design of a product.

In particular, since the support device 1 uses the gaze information as described above instead of product purchasers' or testers' simple impressions, it is possible to provide the scientific basis on how the design of the target product looks by the gaze information.

### Second Example Embodiment

Hereinafter, a second example embodiment according to the present invention will be described. In the description of the second example embodiment, the same components as those of the product design generation support device (support device) 1 of the first example embodiment will be denoted with the same reference numerals, and redundant description of the common components will be omitted.

A support device 1 of the second example embodiment also uses opinion information of target persons for the classification of designs 31. The opinion information is information indicating the opinions of testers 40 on the designs 31 of a target product 30 obtained by a questionnaire conducted at a test such as a CLT on product designs, for example. Specifically, the opinion information includes opinions indicating whether or not the target persons want to purchase the target product 30 at the sight of the target product 30 (hereinafter, also referred to as purchase intention), text indicating comments on the designs 31 of the target product 30, and the like. The opinion information is not limited to the above as long as it is information indicating the testers' opinions on the product designs.

That is, in the second example embodiment, an acquisition unit 11 of an arithmetic device 10 acquires the opinion information of the target persons (testers 40) in addition to the design information and the gaze information of the target persons (testers 40) described in relation to the first example embodiment.

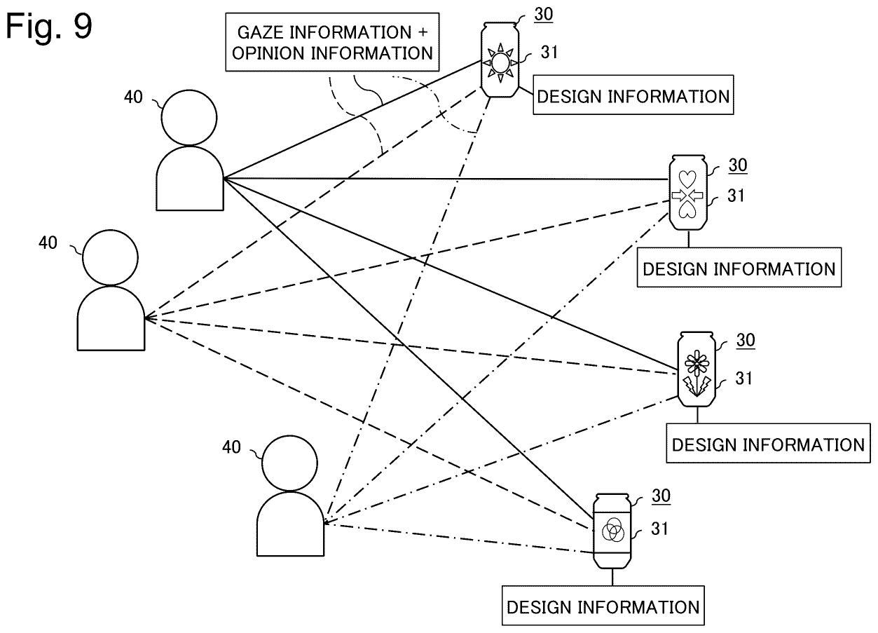

In the second example embodiment, a design classification unit 12 generates a graph as illustrated in FIG. 9. The graph presented in FIG. 9 is a graph in which the gaze information and the opinion information are set as edges, and the designs 31 of the target product 30 and the target persons (testers 40) are set as nodes. The design classification unit 12 generates feature vectors of the nodes and edges in the graph including the opinion information by using a model 22 by the graph AI technology.

The design classification unit 12 classifies the plurality of designs 31 of the target product 30 into a plurality of clusters using the feature vectors of the nodes in the graph including the opinion information. That is, in the second example embodiment, the design classification unit 12 classifies the plurality of designs 31 into a plurality of clusters by using the opinion information of the target persons as well. Specific examples of the clusters include a cluster of designs in which the opinion information is reflected, the purchase intention is high, and attention is focused on the key visual, and a cluster of designs in which there are many comments on the colors and the gaze staying time for the nutrition labeling is long.

The configuration other than the above of the support device 1 of the second example embodiment is similar to the configuration of the support device 1 of the first example embodiment.

As in the first example embodiment, the support device 1 of the second example embodiment outputs the classification results obtained by classifying the plurality of designs 31 of the target product 30 into the plurality of clusters using the gaze information, so that the same advantageous effects as those of the support device 1 of the first example embodiment can be obtained. In addition, the support device 1 of the second example embodiment classifies the designs taking into account the opinion information of the target persons on the designs 31, whereby it is possible to provide more effective information on how the designs of the product look and to suitably support the implementation (generation) of design of the product.

### Third Example Embodiment

Hereinafter, a third example embodiment according to the present invention will be described. In the description of the third example embodiment, the same components as those of the product design generation support device (support device) 1 of the first or second example embodiment will be denoted with the same reference numerals, and redundant description of the common components will be omitted.

A support device 1 of the third example embodiment has, in addition to the configuration of the support device 1 of the first or second example embodiment, a function of estimating reasons for classification of designs 31 by a design classification unit 12 and outputting the reasons for classification by an output unit 13. That is, in the third example embodiment, the design classification unit 12 not only classifies the plurality of designs 31 of a target product 30 into a plurality of clusters, but also estimates the reasons for classification. As a method of estimating the reasons for classification, for example, the design classification unit 12 uses a model for classification reason estimation. The model for classification reason estimation is a model that is stored in a storage device 20 or a storage device 25 and has learned rules for classifying (clustering) a plurality of designs into a plurality of clusters based on feature vectors of the designs. In the third example embodiment, this model is not used for classification of the design 31 but used for estimation of reasons for classification. That is, the design classification unit 12 estimates rules for classifying the designs so as to, after classifying the plurality of designs 31 of the target product 30 into a plurality of clusters by models 22 and 23 by the model for classification reason estimation, obtain the relevant classification results. The design classification unit 12 then estimates the reasons for classification using the rules estimated by the model for classification reason estimation. For example, as illustrated in FIG. 7, it is assumed that the plurality of designs 31 is classified into clusters A and B. It is also assumed that the model for classification reason estimation estimates based on the classification results that one of rules on which designs 31 are classified into the cluster A is that the gaze staying time on the key visual is longer than average, for example. In such a case, the design classification unit 12 estimates a reason for classifying into the cluster A is that the gaze staying time on the key visual is longer than average.

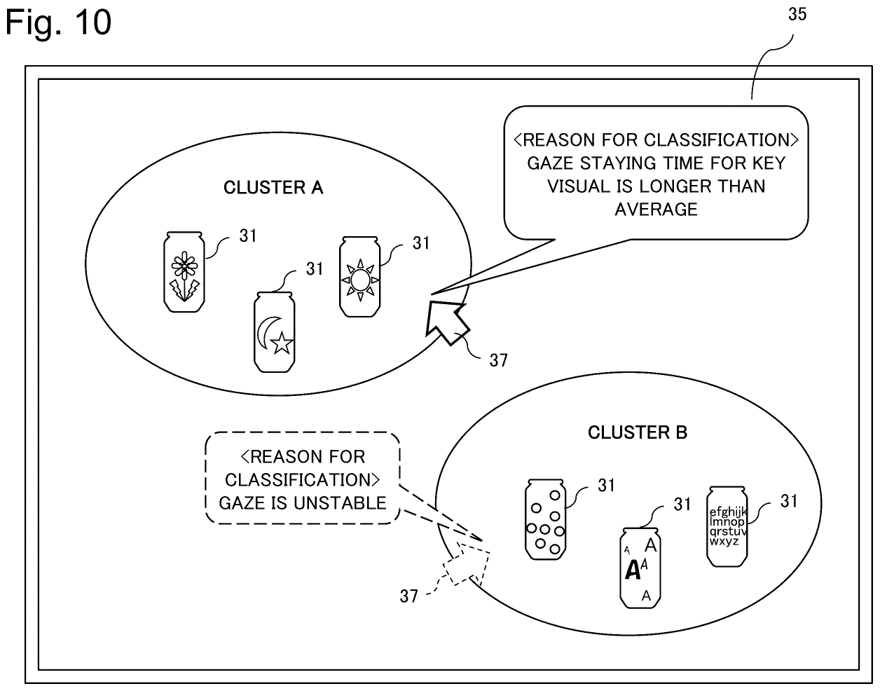

The output unit 13 outputs information on the reasons for classification estimated by the design classification unit 12 in addition to the cluster information. The information on the reasons for classification includes cluster identification information of the corresponding cluster, for example. Such information on the reasons for classification is transmitted to a terminal device 3, for example, and is displayed on the display device by the display control operation of the terminal device 3. FIG. 10 is a diagram illustrating a display example on the display device indicating the reasons for classification. In the example of FIG. 10, the reason for classification related to the cluster designated by a pointer 37 is popped up on a screen 35 of the display device on which the cluster information is displayed.

The configuration other than the above of the support device 1 of the third example embodiment is similar to the configuration of the support device 1 of the first or second example embodiment.

As in the first or second example embodiment, the support device 1 of the third example embodiment outputs the classification results obtained by classifying the plurality of designs 31 of the target product 30 into the plurality of clusters using the gaze information, so that the same advantageous effects as those of the support device 1 of the first or second example embodiment can be obtained. Furthermore, since the support device 1 of the third example embodiment outputs the reasons for classification of the designs, it is possible to provide information that facilitates interpretation of the clusters of the designs.

### Fourth Example Embodiment

Hereinafter, a fourth example embodiment according to the present invention will be described. In the description of the fourth example embodiment, the same components as those of the product design generation support devices (support devices) 1 of the first to third example embodiment will be denoted with the same reference numerals, and redundant description of the common components will be omitted.

A support device 1 of the fourth example embodiment also uses person attribute information on the target persons (testers 40) for the design classification. Examples of the person attribute information include age, lifestyle information (for example, meal information such as the number of meals and meal hours of the day, the amount of exercise in one week, sleeping hours, wake-up time, bed time, and commute hours), preference information, and hobbies. The person attribute information used by the support device 1 is appropriately selected in consideration of the type of the target product and the like.

In the fourth example embodiment, the person attribute information is transmitted from a terminal device 3 to the support device 1, for example. The person attribute information can be acquired by a questionnaire at a test site or the like of a CLT. If the testers 40 are selected from persons who have registered the attribute information in advance as described above, for example, the person attribute information can be acquired from the registered information.

An acquisition unit 11 acquires the person attribute information as described above in addition to the information acquired in the first to third example embodiments.

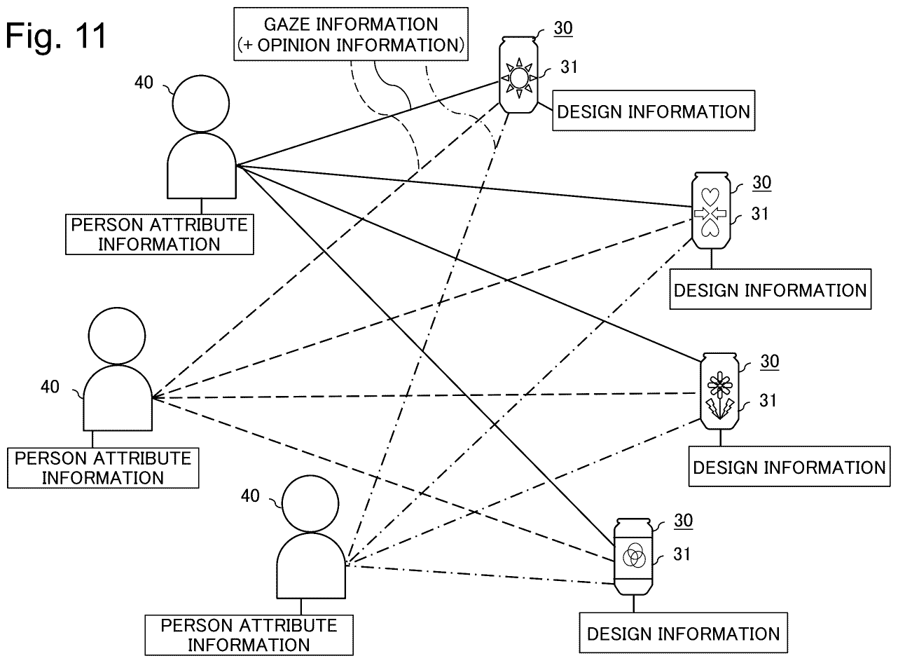

As in the first to third example embodiments, after generating a graph (knowledge graph) as illustrated in FIG. 11, a design classification unit 12 generates a feature vector of each node in the graph using a model 22 by the graph AI technology. In the fourth example embodiment, the feature vector includes a vector element based on the person attribute information.

The design classification unit 12 classifies a plurality of designs 31 of a target product 30 into a plurality of clusters using such feature vectors including the person attribute information. Specific examples of the clusters in the fourth example embodiment include, reflecting the person attribute information, a cluster of designs in which persons who drink at a frequency of about once a week may pay attention to the title of the product, a cluster of designs that persons who like sports may want to purchase the product at a glance, and the like.

The configuration other than the above of the support device 1 of the fourth example embodiment is similar to the configuration of the support device 1 of any one of the first to third example embodiments.

As in the first to third example embodiments, the support device 1 of the fourth example embodiment outputs the classification results obtained by classifying the plurality of designs 31 of the target product 30 into the plurality of clusters using the gaze information, so that the same advantageous effects as those of the support device 1 of the first to third example embodiments can be obtained. The support device 1 according to the fourth example embodiment also generates clusters reflecting the person attribute information. Accordingly, if a group of persons to be noted is determined at the time of product design, the product developer, the designer, and the like can easily acquire information that is more effective for implementation of design by referring to the information of the cluster related to the person attribute information corresponding to the group.

### Fifth Example Embodiment

Hereinafter, a fifth example embodiment according to the present invention will be described. In the description of the fifth example embodiment, the same components as those of the product design generation support devices (support devices) 1 of the first to fourth example embodiment will be denoted with the same reference numerals, and redundant description of the common components will be omitted.

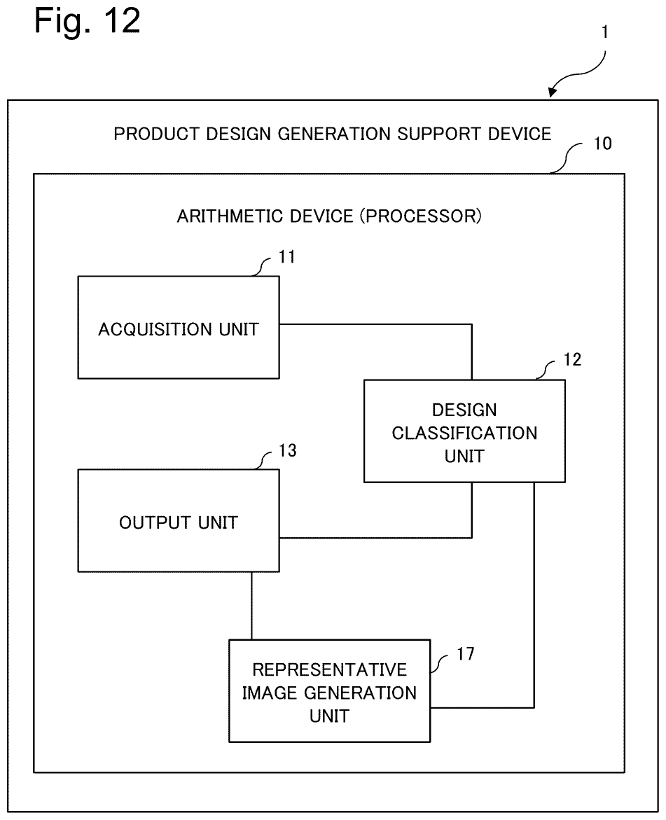

A support device 1 of the fifth example embodiment includes a representative image generation unit 17 as illustrated in FIG. 12 in addition to the configuration of the support device 1 of any one of the first to fourth example embodiments. FIG. 12 does not illustrate a storage device 20, a storage device 25, and a terminal device 3 constituting the support device 1.

The representative image generation unit 17 generates a representative image that shows a representative design in each cluster of designs 31 classified by the design classification unit 12. A method for generating a representative image in a cluster is not limited, and there is a method using a model for image generation, for example. The model for image generation is a model that learns the design images of the target product 30 and generates design images corresponding to the input feature amount. In a case of using such a model for image generation, the representative image generation unit 17 calculates average feature amounts (feature vectors) of the designs 31 classified into clusters, and inputs the calculated feature amounts to the model for image generation, for example. The representative images of the designs in the individual clusters are generated by the model for image generation.

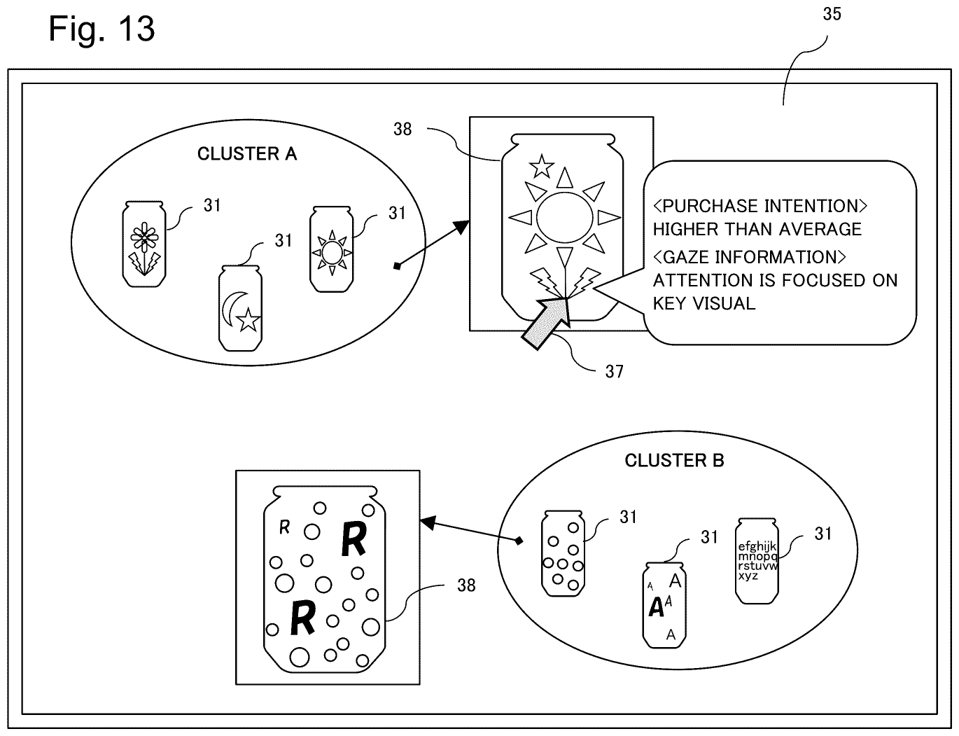

The output unit 13 outputs representative images in the clusters in addition to the cluster information. The representative images in the clusters are associated with cluster identification information representing the corresponding clusters. The representative images in the clusters are transmitted to the terminal device 3, for example, and are displayed on the display device by the display control operation of the terminal device 3. FIG. 13 is a diagram illustrating a display example on the display device representing the cluster information and the representative images. In the example of FIG. 13, on the screen 35 of the display device on which the cluster information is displayed, the representative images 38 in the clusters are displayed in modes associated with the corresponding clusters. When any of the representative images 38 is designated by the pointer 37 on the screen 35, one or both of the opinion information (purchase intention and comments) and the gaze information related to the cluster corresponding to the representative image 38 may be popped up. In this case, the opinion information and the gaze information related to the clusters are output from the output unit 13.

The configuration other than the above of the support device 1 of the fifth example embodiment is similar to the configuration of the support device 1 of any one of the first to fourth example embodiments.

As in the first to fourth example embodiments, the support device 1 of the fifth example embodiment can output the classification results obtained by classifying the plurality of designs 31 of the target product 30 into the plurality of clusters using the gaze information, so that the same advantageous effects as those of the support device 1 of the first to fourth example embodiments can be obtained. The support device 1 of the fifth example embodiment can provide information that facilitates interpretation of the clusters by outputting the representative images of the designs classified into the clusters.

### Sixth Example Embodiment

Hereinafter, a sixth example embodiment according to the present invention will be described. In the description of the sixth example embodiment, the same components as those of the product design generation support devices (support devices) 1 of the first to fifth example embodiment will be denoted with the same reference numerals, and redundant description of the common components will be omitted.

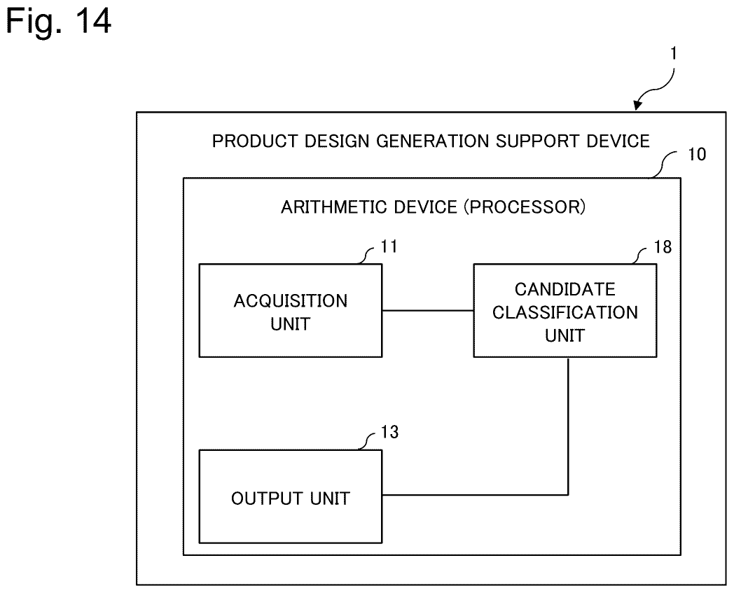

A support device 1 according to the sixth example embodiment has a function of using cluster information generated by the support devices 1 in the first to fifth example embodiments. That is, in the sixth example embodiment, the support device 1 includes a candidate classification unit 18 as illustrated in FIG. 14. FIG. 14 does not illustrate a storage device 20, a storage device 25, a terminal device 3, and a design classification unit 12 and a representative image generation unit 17 in an arithmetic device 10.

In the sixth example embodiment, an acquisition unit 11 acquires candidate images representing design candidates of a target product 30 from the terminal device 3, for example. For example, the candidate classification unit 18 collates the candidate images with information of a plurality of clusters related to the designs of the target product 30 stored in the storage device 20, and classifies the design candidates into one of the clusters. The output unit 13 outputs information indicating the cluster into which the design candidates are classified.

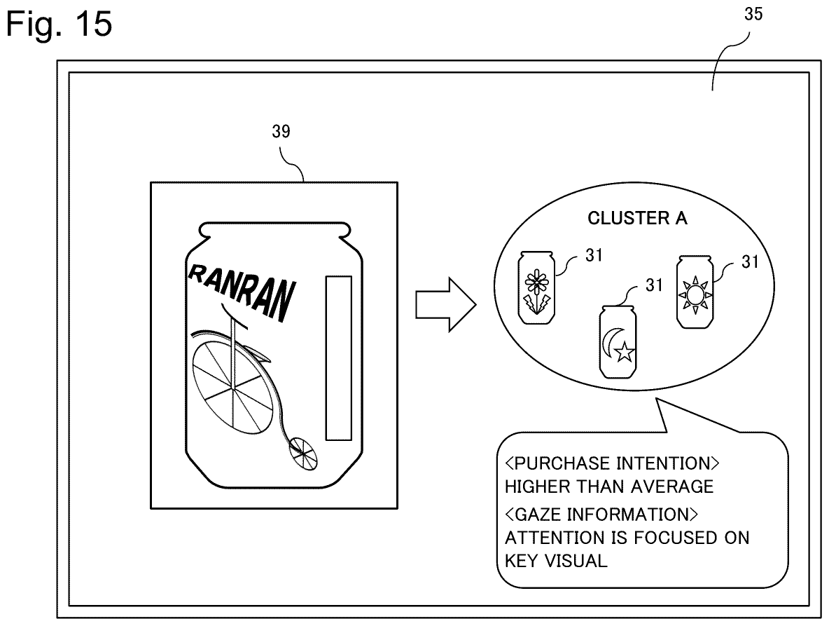

The information on the cluster classification of the design candidates output from the output unit 13 is transmitted to the terminal device 3, for example, and is displayed on the display device by the display control operation of the terminal device 3. FIG. 15 illustrates a display example on the display device representing information on cluster classification of design candidates. In the example of FIG. 15, a candidate image 39 representing a design candidate, a cluster into which the design candidate is classified, and opinion information and gaze information related to the cluster are displayed on a screen 35 of the display device.

As in the first to fifth example embodiments, the support device 1 of the sixth example embodiment can output the classification results obtained by classifying a plurality of designs 31 of the target product 30 into the plurality of clusters using the gaze information, so that the same advantageous effects as those of the support device 1 of the first to fifth example embodiments can be obtained. The support device 1 of the sixth example embodiment can further provide information on clusters into which design candidates of the target product 30 are classified. That is, since the support device 1 can provide the information on how the design candidates of the target product 30 look, the efficiency of implementation of design of the target product 30 can be further promoted.

### Other Example Embodiments

The present invention is not limited to the first to sixth example embodiments, and various embodiments can be adopted. For example, in the first to sixth example embodiments, the support devices 1 have been described by taking the package design as an example of the product design. However, the design of the target product targeted by the support devices 1 of the first to sixth example embodiments is not limited to the package design. For example, the design of the target product targeted by the support devices 1 of the first to sixth example embodiments may be a design of an object contained in a package or a design of a product itself without a package.

In the first to sixth example embodiments, the gaze information and opinion information of target persons with respect to a design of a target product are acquired in a CLT. Alternatively, the gaze information and the opinion information of target persons with respect to the design of the target product may be acquired by a questionnaire survey on the street, for example. In this case, the target persons are persons who respond to a questionnaire on the street, and the gaze information of the target persons can be acquired from images (or moving images) obtained by imaging the target persons responding to the questionnaire by an imaging device in the same manner as described above. In the first to sixth example embodiments, the gaze information obtained from the target persons who are directly looking at the target product 30 or the opinion information obtained from the target persons who have directly looked at the target product 30 is used. Instead of this, for example, the gaze information obtained from the target persons who are looking at advertisements of the target product 30 in newspapers, magazines, television, or websites or advertisements of the target product 30 in public transportation facilities, or the opinion information obtained from the target persons who have looked at such advertisements of the target product 30 may be used. In addition, the gaze information or opinion information obtained from the target persons who are directly looking at or have directly looked at the target product 30 and the gaze information or opinion information obtained from the target persons who are looking at or have looked at advertisements of the target product 30 may be used. That is, by using the design information on the design of the target product 30 placed in advertisements as described above and the gaze information of the target persons with respect to the design, it is also possible to classify the designs of the target product 30 placed in advertisements into clusters in the same manner as described above.

The support devices 1 of the first to sixth example embodiments may construct a product design generation support system together with the connected terminal device 3, for example.

In the first to sixth example embodiments, the design classification unit 12 classifies designs into a plurality of groups (clusters) using a clustering model 23. Alternatively, the design classification unit 12 may classify a plurality of designs into a plurality of groups by another method such as classifying designs using statistical processing, for example.

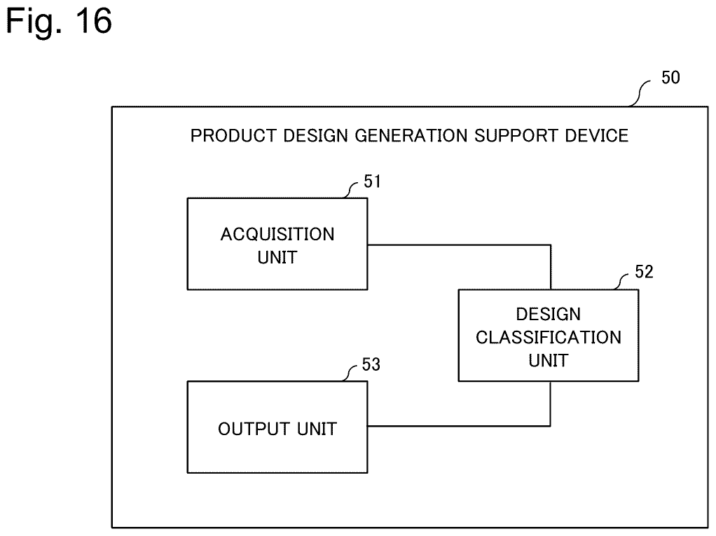

FIG. 16 is a block diagram illustrating a minimum configuration of a product design generation support device. The product design generation support device 50 includes an acquisition unit 51, a design classification unit 52, and an output unit 53. The product design generation support device 50 is a computer device, for example, and the acquisition unit 51, the design classification unit 52, and the output unit 53 are implemented as in the first to sixth example embodiments.

The acquisition unit 51 acquires design information of each of a plurality of designs of the subject product that are different to each other and gaze information of the subject person for those designs. The design classification unit 52 classifies the plurality of designs into a plurality of groups according to the acquired design information and gaze information. The output unit 53 outputs the classification results.

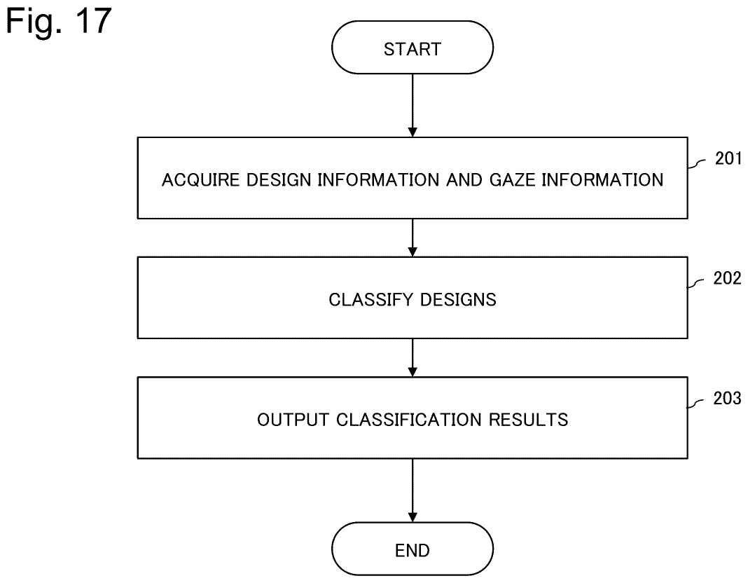

FIG. 17 is a flowchart illustrating an example of operations of the product design generation support device 50. For example, the acquisition unit 51 acquires design information of each of a plurality of designs of the subject product that are different to each other and gaze information of the subject person for those designs (step 201). After that, the design classification unit 52 classifies the plurality of designs into a plurality of groups according to the acquired design information and gaze information (step 202). The output unit 53 outputs the classification results (step 203).

With the configuration as described above, the product design generation support device 50 can generate and present information effective for implementing and determining product designs.

Some or all of the above example embodiments may be described as the following supplementary notes, but are not limited to the following.

(Supplementary Note 1)

A product design generation support device including:
an acquisition means configured to acquire design information of each of a plurality of different designs of a target product and gaze information of a target person to the design;
a design classification means configured to classify the plurality of designs into a plurality of groups based on the design information and the gaze information acquired by the acquisition means; and
an output means configured to output a result of the classification.

(Supplementary Note 2)

The product design generation support device according to Supplementary Note 1, wherein
the gaze information includes at least one of a trajectory of a gaze of the target person with respect to the designs and a gaze staying time of the target person with respect to the designs.

(Supplementary Note 3)

The product design generation support device according to Supplementary Note 1 or 2, wherein
the acquisition means further acquires person attribute information on the target person, and
the design classification means classifies the plurality of designs further based on the person attribute information.

(Supplementary Note 4)

The product design generation support device according to any one of Supplementary Notes 1 to 3, wherein
the acquisition means further acquires opinion information of the target person with respect to the designs, and
the design classification means classifies the plurality of designs further based on the opinion information.

(Supplementary Note 5)

The product design generation support device according to any one of Supplementary Notes 1 to 4, wherein
the design classification means estimates a reason for classification of the designs based on the gaze information of the target person with respect to the designs, and
the output means further outputs the reason for classification.

(Supplementary Note 6)

The product design generation support device according to any one of Supplementary Notes 1 to 5, wherein
the design classification means classifies the plurality of designs into the plurality of groups using a clustering model, and
the clustering model is a model that classifies the plurality of designs into the plurality of groups using a feature amount of the designs based on the design information and the gaze information.

(Supplementary Note 7)

The product design generation support device according to any one of Supplementary Notes 1 to 6, further including
a representative image generation means configured to generate a representative image of a representative of the designs included in the groups by using the design information and information of the group, wherein
the output means further outputs the representative image.

(Supplementary Note 8)

The product design generation support device according to Supplementary Note 7, wherein
the output means further outputs the gaze information related to the representative image.

(Supplementary Note 9)

The product design generation support device according to Supplementary Note 7 or 8, wherein
the acquisition means further acquires opinion information of the target person with respect to the designs, and
the output means further outputs the opinion information related to the representative image.

(Supplementary Note 10)

The product design generation support device according to any one of Supplementary Notes 1 to 9, wherein
the acquisition means further acquires a candidate image representing a design candidate of the target product, and
the product design generation support device further includes a candidate classification means configured to classify the design candidate into one of the groups by using the candidate image and the information of the group, and
the output means outputs information indicating the group into which the design candidate is classified.

(Supplementary Note 11)

A product design generation support system including:
an acquisition means configured to acquire design information of each of a plurality of different designs of a target product and gaze information of a target person to the design;
a design classification means configured to classify the plurality of designs into a plurality of groups based on the design information and the gaze information acquired by the acquisition means; and
an output means configured to output a result of the classification.

(Supplementary Note 12)

A product design generation support method including:
by a computer,
acquiring design information of each of a plurality of different designs of a target product and gaze information of a target person to the design;
classifying the plurality of designs into a plurality of groups based on the design information and the gaze information; and
outputting a result of the classification.

(Supplementary Note 13)

A program storage medium storing a computer program for causing a computer to execute:
acquiring design information of each of a plurality of different designs of a target product and gaze information of a target person to the design;
classifying the plurality of designs into a plurality of groups based on the design information and the gaze information; and
outputting a result of the classification.

The present invention has been described above using the above-described example embodiments as exemplary examples. However, the present invention is not limited to the above-described example embodiments. That is, the present invention can apply various aspects that can be understood by those skilled in the art within the scope of the present invention.

### REFERENCE SIGNS LIST

1, 50 Product design generation support device
11, 51 Acquisition unit
12, 52 Design classification unit
13, 53 Output unit
17 Representative image generation unit
18 Candidate classification unit

What is claimed is:

1. A product design generation support device comprising:
a memory configured to store instructions; and
a processor configured to execute the instructions to:
acquire design information of each of a plurality of different designs of a target product and gaze information of a target person to the design;
classify the plurality of designs into a plurality of groups based on the design information and the acquired gaze information; and
output a result of the classification.

2. The product design generation support device according to claim 1, wherein
the gaze information includes at least one of a trajectory of a gaze of the target person with respect to the designs and a gaze staying time of the target person with respect to the designs.

3. The product design generation support device according to claim 1, wherein
the processor is configured to acquire further person attribute information on the target person, and
the processor is configured to classify the plurality of designs further based on the person attribute information.

4. The product design generation support device according to claim 1, wherein
the processor is configured to acquire further opinion information of the target person with respect to the designs, and
the processor is configured to classify the plurality of designs further based on the opinion information.

5. The product design generation support device according to claim 1, wherein
the processor is further configured to estimate a reason for classification of the designs based on the gaze information of the target person with respect to the designs, and
the processor is configured to output further the reason for classification.

6. The product design generation support device according to claim 1, wherein
the processor is configured to classify the plurality of designs into the plurality of groups using a clustering model, and
the clustering model is a model that classifies the plurality of designs into the plurality of groups using a feature amount of the designs based on the design information and the gaze information.

7. The product design generation support device according to claim 1, wherein
the processor is further configured to generate a representative image of a representative of the designs included in the groups by using the design information and information of the group, wherein
the processor is configured to output further the representative image.

8. The product design generation support device according to claim 7, wherein
the processor is configured to output further the gaze information related to the representative image.

9. The product design generation support device according to claim 7, wherein
the processor is configured to acquire further opinion information of the target person with respect to the designs, and
the processor is configured to output further the opinion information related to the representative image.

10. The product design generation support device according to claim 1, wherein
the processor is configured to acquire further a candidate image representing a design candidate of the target product, and
the processor is further configured to classify the design candidate into one of the plurality of groups by using the candidate image and the information of the group, and
the processor is configured to output information indicating the group into which the design candidate is classified.

11. (canceled)

12. A product design generation support method comprising:
by a computer,
acquiring design information of each of a plurality of different designs of a target product and gaze information of a target person to the design;
classifying the plurality of designs into a plurality of groups based on the design information and the gaze information; and
outputting a result of the classification.

13. A non-transitory computer readable medium storing a computer program for causing a computer to execute:
acquiring design information of each of a plurality of different designs of a target product and gaze information of a target person to the design;
classifying the plurality of designs into a plurality of groups based on the design information and the gaze information; and
outputting a result of the classification.
